(19) United States
(12) Patent Application Publication
(10) Pub. No.: US 2026/0052583 A1
(43) Pub. Date: Feb. 19, 2026

(54) ROUTING PACKET DATA UNIT (PDU) SESSION REQUESTS IN OVERLAPPING COVERAGE AREAS BASED ON IDENTIFICATION INFORMATION

(71) Applicant: T-Mobile USA, Inc., Bellevue, WA (US)

(72) Inventor: Romil Kumar Sood, Bothell, WA (US)

(21) Appl. No.: 18/804,086

(22) Filed: Aug. 14, 2024

(51) Int. Cl. H04W 76/10; H04W 8/04; H04W 48/02; H04W 60/06

(52) U.S. Cl. CPC H04W 76/10; H04W 8/04; H04W 48/02; H04W 60/06

(57) ABSTRACT

The disclosed technology performs routing of PDU session requests in overlapping coverage areas based on identification information associated with the PDU session requests. Upon receiving the PDU session request initiated from a wireless device, a roaming proxy of a home network retrieves identification information associated with the PDU session request. Based on the identification information, the roaming proxy determines whether the PDU session request was created in an overlapping area of two coverage areas of the home network and a visited network. The roaming proxy notifies a network node of the home network to allow or reject the PDU session request based on the determination. The roaming proxy further notifies a network node of the home network to de-register the wireless device from the visited network.

### BACKGROUND

Data roaming is the use of cellular data services on a mobile device outside of the coverage area of the home network. When traveling outside the geographic coverage area of the home network, the wireless device with roaming capabilities can automatically connect to the available visited network to receive services. Roaming allows users to talk, text, and use the internet outside of their wireless provider's coverage area, but can also lead to increased cost, unwanted usage, and security issues.

### BRIEF DESCRIPTION OF THE DRAWINGS

Detailed descriptions of implementations of the present invention will be described and explained through the use of the accompanying drawings.

FIG. 1 is a block diagram that illustrates network nodes located within coverage areas of a home network and a visited network.

FIG. 2 is a block diagram that illustrates a wireless communications system that can implement aspects of the present technology.

FIG. 3 is a block diagram that illustrates 5G core network functions (NFs) that can implement aspects of the present technology.

FIG. 4 is a flowchart representation of an example routing process of a PDU session request based on identification information in accordance with one or more embodiments of the present technology.

FIG. 5 is a flowchart representation of another example routing process of a PDU session request based on identification information in accordance with one or more embodiments of the present technology.

FIG. 6 is a flowchart representation of an example process for routing a PDU session request in an overlapping coverage area in accordance with one or more embodiments of the present technology.

FIG. 7 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

In telecommunications, a 5G network includes multiple radio stations, also referred to as network nodes, that work together to provide communication services to subscribers of the 5G network. Each network node is associated with a geographic area such that a subscriber of the 5G network attaching to a network node via a PDU session request receives services by the network node as long as the subscriber remains within the geographic area of the network node. The geographic areas of the multiple network nodes within the 5G network make up a home coverage area of a home network.

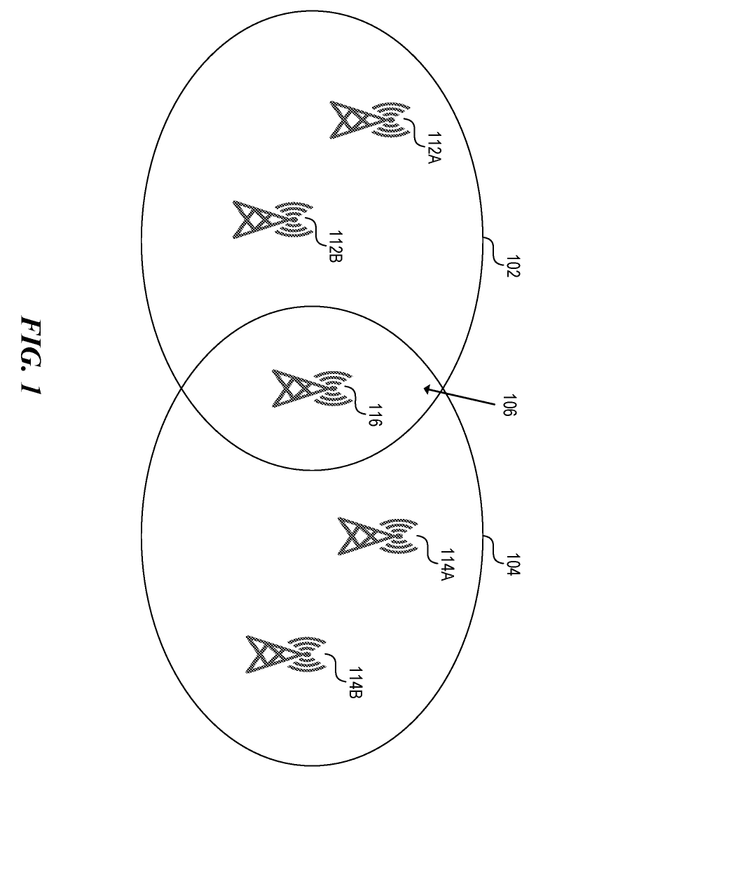

FIG. 1 is a block diagram that illustrates network nodes located within coverage areas of a home network and a visited network. As illustrated in FIG. 1, the home network, also known as a home public land mobile network (HPLMN), is associated with a home coverage area 102. Subscribers of the home network within the home coverage area 102 can attach to network nodes within the home coverage area 102, such as network nodes 112A-B and 116, for service. The visited network, also known as the visited public land mobile network (VPLMN), is associated with a visited coverage area 104. Devices located within the visited coverage area 104 can attach to network nodes within the visited coverage area 104, such as network nodes 114A-B and 116, for service. The home network can work with partner networks to provide broader service coverage for its subscribers. Subscribers of the home network traveling outside of the home coverage area 102 of the home network can attach to network nodes of the visited network, such as network nodes 114A-B. This is also known as roaming, and subscribers of the home network can receive services from the visited network, which results in roaming charges for the subscribers using the visited network and the home network that is partnered with the visited network.

Depending on the locations of network nodes of the home network and the visited network, the coverage areas of the home network and the visited network may overlap, creating an overlapping coverage area, similar to overlapped area 106 of FIG. 1. When a user moves towards the edge of the home coverage area 102 of the home network, a handover to the visited network can be triggered inadvertently, resulting in roaming charges for both the affected subscribers and the home network. However, to reduce or minimize unnecessary cost for the users as well as the network operators, it is desirable to give preference to the home network when the user is located within the overlapped area 106 and initiates a request to attach to the network node 116. Currently, there is no standard procedure to restrict accidental roaming to the visited network in border coverage areas and overlapping coverage areas.

This document discloses techniques can be implemented in various embodiments to address the challenges caused by accidental roaming scenarios. In some embodiments, a home Security Edge Protection Proxy (hSEPP) can be configured to determine availability of the home network, in response to a PDU session request by a wireless device, based on identification information associated with the wireless device and the network node which the wireless device attaches to. Upon determining that the network node is within the coverage area of the home network, the home network can restrict accidental roaming, preventing accidental roaming charges for the wireless device and the home network.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### [Likely required: 5G background] Wireless Communications System

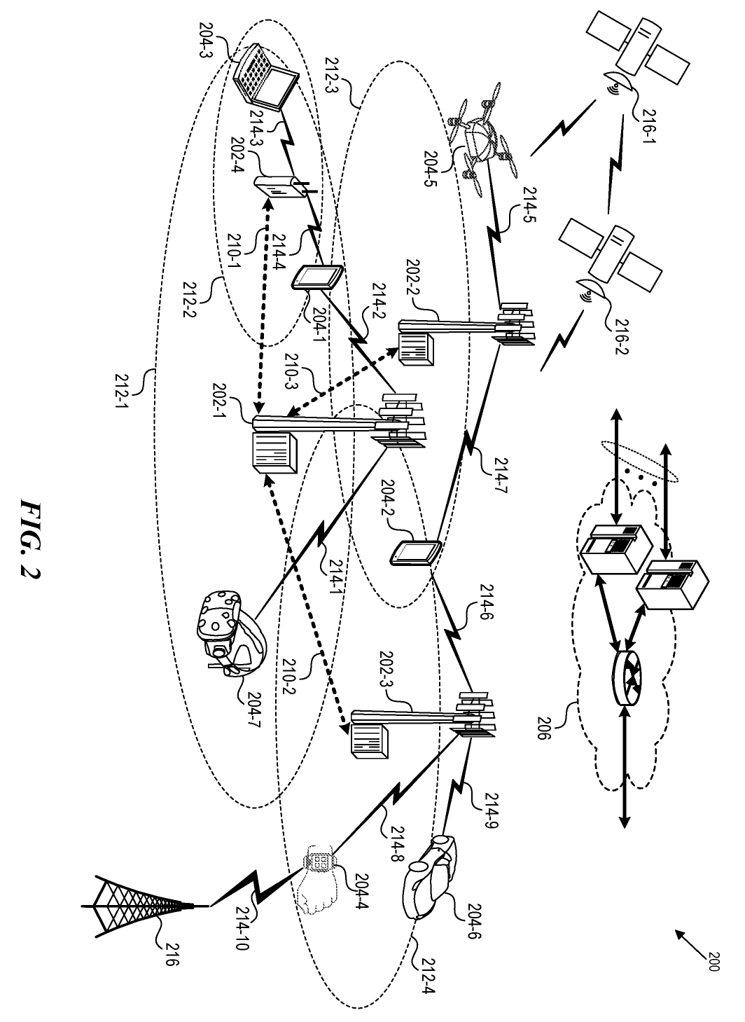

FIG. 2 is a block diagram that illustrates a wireless telecommunication network 200 (“network 200”) in which aspects of the disclosed technology are incorporated. The network 200 includes base stations 202-1 through 202-4 (also referred to individually as “base station 202” or collectively as “base stations 202”). A base station is a type of network access node (NAN) that can also be referred to as a cell site, a base transceiver station, or a radio base station. The network 200 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 200 formed by the network 200 also include wireless devices 204-1 through 204-7 (referred to individually as “wireless device 204” or collectively as “wireless devices 204”) and a core network 206. The wireless devices 204 can correspond to or include network 200 entities capable of communication using various connectivity standards. For example, a 5G communication channel can use millimeter wave (mmW) access frequencies of 28 GHz or more. In some implementations, the wireless device 204 can operatively couple to a base station 202 over a long-term evolution/long-term evolution-advanced (LTE/LTE-A) communication channel, which is referred to as a 4G communication channel.

The core network 206 provides, manages, and controls security services, user authentication, access authorization, tracking, internet protocol (IP) connectivity, and other access, routing, or mobility functions. The base stations 202 interface with the core network 206 through a first set of backhaul links (e.g., S1 interfaces) and can perform radio configuration and scheduling for communication with the wireless devices 204 or can operate under the control of a base station controller (not shown). In some examples, the base stations 202 can communicate with each other, either directly or indirectly (e.g., through the core network 206), over a second set of backhaul links 210-1 through 210-3 (e.g., X1 interfaces), which can be wired or wireless communication links.

The base stations 202 can wirelessly communicate with the wireless devices 204 via one or more base station antennas. The cell sites can provide communication coverage for geographic coverage areas 212-1 through 212-4 (also referred to individually as “coverage area 212” or collectively as “coverage areas 212”). The coverage area 212 for a base station 202 can be divided into sectors making up only a portion of the coverage area (not shown). The network 200 can include base stations of different types (e.g., macro and/or small cell base stations). In some implementations, there can be overlapping coverage areas 212 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 200 can include a 5G network 200 and/or an LTE/LTE-A or other network. In an LTE/LTE-A network, the term “eNBs” is used to describe the base stations 202, and in 5G new radio (NR) networks, the term “gNBs” is used to describe the base stations 202 that can include mmW communications. The network 200 can thus form a heterogeneous network 200 in which different types of base stations provide coverage for various geographic regions. For example, each base station 202 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 200 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 200 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 200 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 204 and the base stations 202 or core network 206 supporting radio bearers for the user plane data. At the Physical (PHY) layer, the transport channels are mapped to physical channels.

Wireless devices can be integrated with or embedded in other devices. As illustrated, the wireless devices 204 are distributed throughout the network 200, where each wireless device 204 can be stationary or mobile. For example, wireless devices can include handheld mobile devices 204-1 and 204-2 (e.g., smartphones, portable hotspots, tablets, etc.); laptops 204-3; wearables 204-4; drones 204-5; vehicles with wireless connectivity 204-6; head-mounted displays with wireless augmented reality/virtual reality (AR/VR) connectivity 204-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 204) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 200 equipment at the edge of a network 200 including macro eNBs/gNBs, small cell eNBs/gNBs, relay base stations, and the like. A wireless device can also communicate with other wireless devices either within or outside the same coverage area of a base station via device-to-device (D2D) communications.

The communication links 214-1 through 214-9 (also referred to individually as “communication link 214” or collectively as “communication links 214”) shown in network 200 include uplink (UL) transmissions from a wireless device 204 to a base station 202 and/or downlink (DL) transmissions from a base station 202 to a wireless device 204. The downlink transmissions can also be called forward link transmissions while the uplink transmissions can also be called reverse link transmissions. Each communication link 214 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 214 can transmit bidirectional communications using frequency division duplex (FDD) (e.g., using paired spectrum resources) or time division duplex (TDD) operation (e.g., using unpaired spectrum resources). In some implementations, the communication links 214 include LTE and/or mmW communication links.

In some implementations of the network 200, the base stations 202 and/or the wireless devices 204 include multiple antennas for employing antenna diversity schemes to improve communication quality and reliability between base stations 202 and wireless devices 204. Additionally or alternatively, the base stations 202 and/or the wireless devices 204 can employ multiple-input, multiple-output (MIMO) techniques that can take advantage of multi-path environments to transmit multiple spatial layers carrying the same or different coded data.

In some examples, the network 200 implements 6G technologies including increased densification or diversification of network nodes. The network 200 can enable terrestrial and non-terrestrial transmissions. In this context, a Non-Terrestrial Network (NTN) is enabled by one or more satellites, such as satellites 216-1 and 216-2, to deliver services anywhere and anytime and provide coverage in areas that are unreachable by any conventional Terrestrial Network (TN). A 6G implementation of the network 200 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 200 can implement a converged Radio Access Network (RAN) and Core architecture to achieve Control and User Plane Separation (CUPS) and achieve extremely low user plane latency. In yet another example of 6G, the network 200 can implement a converged Wi-Fi and Core architecture to increase and improve indoor coverage.

### [Likely required: 5G background] 5G Core Network Functions

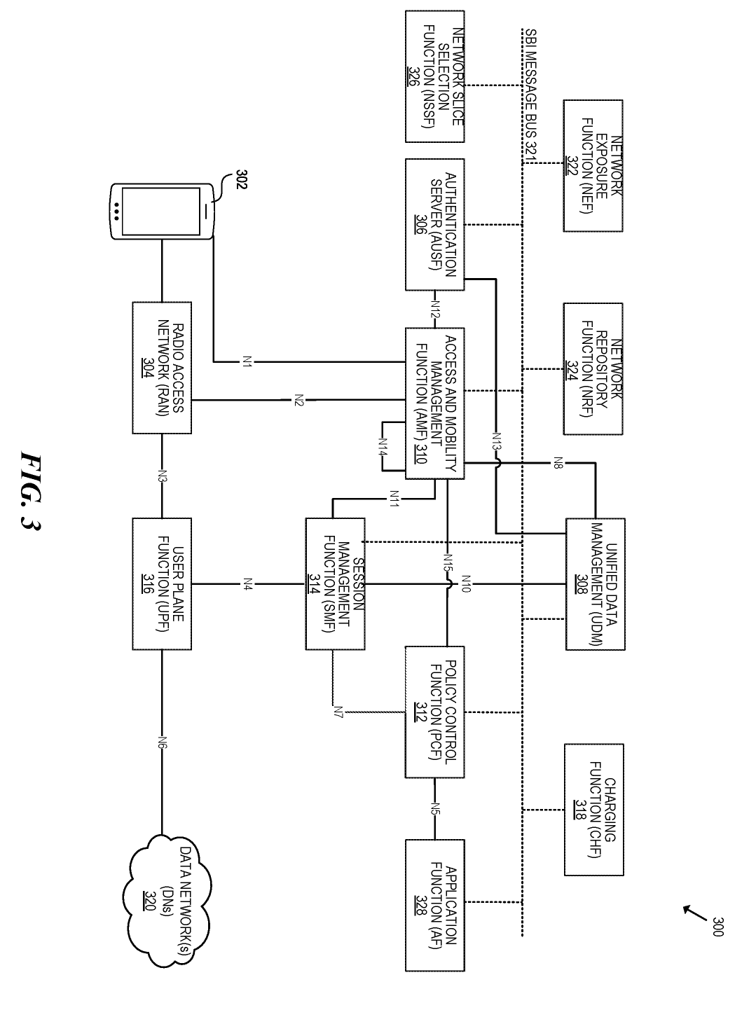

FIG. 3 is a block diagram that illustrates an architecture 300 including 5G core network functions (NFs) that can implement aspects of the present technology. A wireless device 302 can access the 5G network through a NAN (e.g., gNB) of a RAN 304. The NFs include an Authentication Server Function (AUSF) 306, a Unified Data Management (UDM) 308, an Access and Mobility management Function (AMF) 310, a Policy Control Function (PCF) 312, a Session Management Function (SMF) 314, a User Plane Function (UPF) 316, and a Charging Function (CHF) 318.

The interfaces N1 through N15 define communications and/or protocols between each NF as described in relevant standards. The UPF 316 is part of the user plane and the AMF 310, SMF 314, PCF 312, AUSF 306, and UDM 308 are part of the control plane. One or more UPFs can connect with one or more data networks (DNs) 320. The UPF 316 can be deployed separately from control plane functions. The NFs of the control plane are modularized such that they can be scaled independently. As shown, each NF service exposes its functionality in a Service Based Architecture (SBA) through a Service Based Interface (SBI) 321 that uses HTTP/2. The SBA can include a Network Exposure Function (NEF) 322, an NF Repository Function (NRF) 324, a Network Slice Selection Function (NSSF) 326, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 324, which maintains a record of available NF instances and supported services. The NRF 324 allows other NF instances to subscribe and be notified of registrations from NF instances of a given type. The NRF 324 supports service discovery by receipt of discovery requests from NF instances and, in response, details which NF instances support specific services.

The NSSF 326 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 302 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 308 and then requests an appropriate network slice of the NSSF 326.

The UDM 308 introduces a User Data Convergence (UDC) that separates a User Data Repository (UDR) for storing and managing subscriber information. As such, the UDM 308 can employ the UDC under 3GPP TS 22.101 to support a layered architecture that separates user data from application logic. The UDM 308 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 308 can contain voluminous amounts of data that is accessed for authentication. Thus, the UDM 308 is analogous to a Home Subscriber Server (HSS) and can provide authentication credentials while being employed by the AMF 310 and SMF 314 to retrieve subscriber data and context.

The PCF 312 can connect with one or more Application Functions (AFs) 328. The PCF 312 supports a unified policy framework within the 5G infrastructure for governing network behavior. The PCF 312 accesses the subscription information required to make policy decisions from the UDM 308 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 324. This allows the SCP to become the delegated discovery point in a datacenter, offloading the NRF 324 from distributed service meshes that make up a network operator’s infrastructure. Together with the NRF 324, the SCP forms the hierarchical 5G service mesh.

The AMF 310 receives requests and handles connection and mobility management while forwarding session management requirements over the N11 interface to the SMF 314. The AMF 310 determines that the SMF 314 is best suited to handle the connection request by querying the NRF 324. That interface and the N11 interface between the AMF 310 and the SMF 314 assigned by the NRF 324 use the SBI 321. During session establishment or modification, the SMF 314 also interacts with the PCF 312 over the N7 interface and the subscriber profile information stored within the UDM 308. Employing the SBI 321, the PCF 312 provides the foundation of the policy framework that, along with the more typical QoS and charging rules, includes network slice selection, which is regulated by the NSSF 326.

### Routing PDU Session Requests in Overlapping Coverage Areas Based on Identification Information

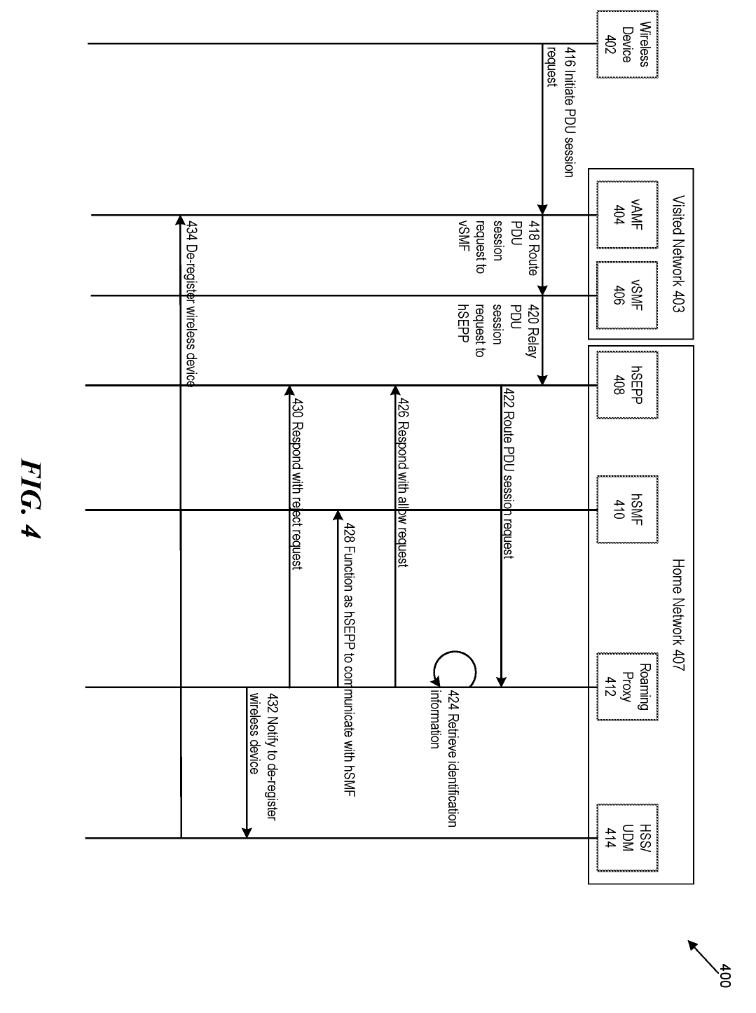

As discussed above, a home network can work with partner networks to provide a broader coverage for its subscribers. However, due to roaming costs associated with a handover to a visited network in areas where home coverage area and visited coverage area overlap, it is desirable to give preference to the home network when a subscriber is located within an overlapped area. FIG. 4 is a flowchart representation of an example routing process 400 of a PDU session request based on identification information in accordance with one or more embodiments of the present technology. Other implementations of the process 400 include additional, fewer, or different network components and/or additional, fewer, or different steps or performing the steps in different orders.

In the example illustrated in FIG. 4, a wireless device 402, at Operation 416, initiates a PDU session request by sending a message to a visited network 403’s Access and Mobility management Function (vAMF) 404. The message is an initial communication signaling the wireless device 402’s intent to establish a data session. As a result of the initial communication, the wireless device 402 is registered with the vAMF 404.

Subsequently, at Operation 418, the vAMF 404 selects an appropriate visited SMF (vSMF) 406 of the visited network 403 for managing the PDU session request and routes the PDU session request. At Operation 420, The vSMF 406 relays the PDU session request to home Security Edge Protection Proxy (hSEPP) 408 of a home network 407.

At Operation 422, the hSEPP 408 routes the PDU session request to a roaming proxy 412 of the home network 407. At Operation 424, the roaming proxy 412 retrieves identification information associated with the PDU session request. The identification information can include mobile country code (MCC), mobile network code (MNC), cell ID of a cell identified in the PDU session request, or tracking area code (TAC) associated with the PDU session request.

At Operation 426, upon determining that the PDU session request was created outside an overlapping area of coverage areas of the home network 407 and the visited network 403, the roaming proxy 412 responds to the hSEPP 408 with a message to allow the PDU session request, indicating the roaming proxy 412 approves of the PDU session request. The PDU session request being created outside the overlapping area can indicate no access nodes of the home network 407 is available within the vicinity of the wireless device 402, and as such, the home network 407 is unable to handle the PDU session request.

At Operation 428, after responding to the hSEPP 408 with the message to allow the PDU session request, the roaming proxy 412 functions as hSEPP 408 to communicate with home SMF (hSMF) 410 of the home network 407. Information communicated to the hSMF 410 can include the determination that the PDU session request was created outside the overlapping area, along with an indication that the roaming proxy 412 responded to the hSEPP 408 with the allow request.

In some embodiments, the roaming proxy 412 determines that the PDU session request was created within the overlapping area of coverage areas of the home network 407 and the visited network 403. The PDU session request created within the overlapping area can indicate that an access node of the home network 407 located within the overlapping area is available. Because of the availability of such access node, roaming to the visited network 403 would be unnecessary. In such scenarios, the roaming proxy 412 can respond to the hSEPP 408 with a reject request, as shown in Operation 430. In other embodiments, the roaming proxy 412 may respond to the hSEPP 408 with the reject request based on an indication that additional identification information is required to determine if the PDU session request was created within the overlapping area.

After sending a reject request to the hSEPP 408, at Operation 432, the roaming proxy 412 sends a notification to a network node 414 of the home network, such as HSS or UDM, to initiate de-registration of the wireless device 402. At Operation 434, the network node 414 de-registers the wireless device 402 from the vAMF 404.

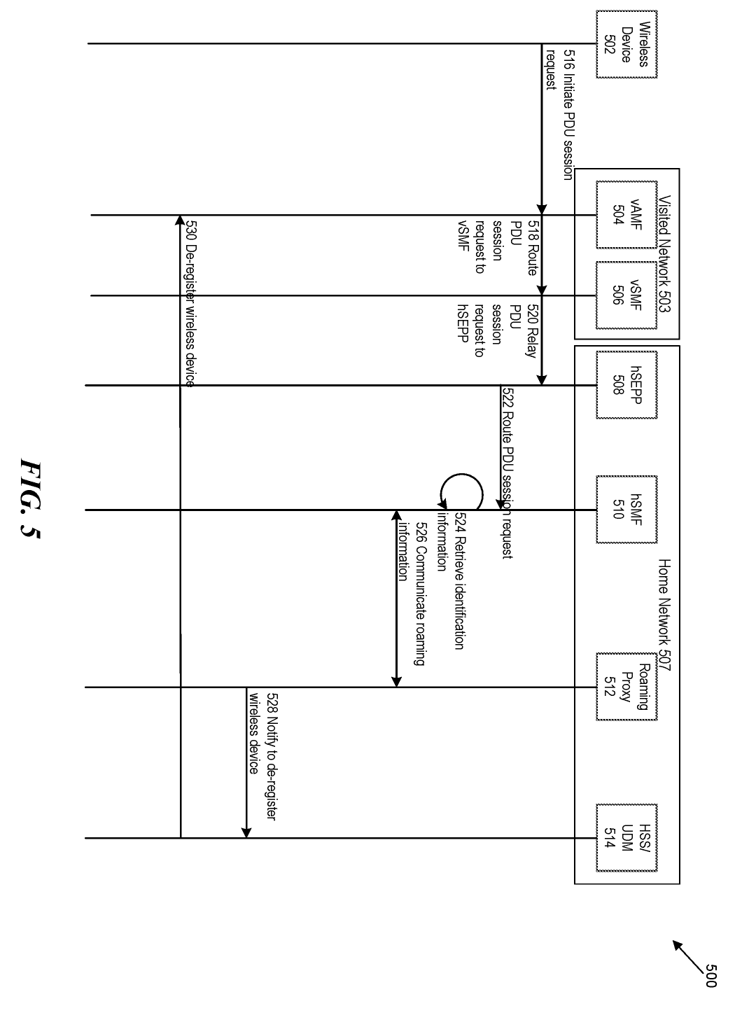

FIG. 5 is a flowchart representation of another example routing process 500 of a PDU session request based on identification information in accordance with one or more embodiments of the present technology. Other implementations of the process 500 include additional, fewer, or different network components and/or additional, fewer, or different steps or performing the steps in different orders.

In the example illustrated in FIG. 5, a wireless device 502, at Operation 516, initiates a PDU session request by sending a message to a vAMF 504 of a visited network 503. The message is an initial communication signaling the wireless device 502’s intent to establish a data session. As a result of the initial communication, the wireless device 502 is registered with the vAMF 504.

Subsequently, at Operation 518, the vAMF 504 selects an appropriate vSMF 506 of the visited network 503 for managing the PDU session request and routes the PDU session request. At Operation 520, The vSMF 506 relays the PDU session request to hSEPP 508 of a home network 507.

At Operation 522, the hSEPP 508 routes the PDU session request to hSMF 510 of the home network 507. At Operation 524, the hSMF 510 retrieves identification information associated with the PDU session request. The identification information can include mobile country code (MCC), mobile network code (MNC), cell ID of a cell identified in the PDU session request, or tracking area code (TAC) associated with the PDU session request. In some embodiments, the hSMF 510 is configured to maintain the identification information as well as a restricted roaming list. The restricted roaming list can include entries indicating MCC, MNC, TAC, or cell ID associated with access nodes of the home network 507 located within an overlapping area of coverage areas of the home network 507 and the visited network 503.

At Operation 526, the hSMF 510 communicates roaming information with a roaming proxy 512 of the home network 507. For example, Operation 526 can comprise the hSMF 510 querying the roaming proxy 512 for a roaming decision for the PDU session request. The hSMF 510 can include the identification information associated with the PDU session request as well as the restricted roaming list. Operation 526 can further comprise the roaming proxy 512 sending a roaming decision to the hSMF 510, wherein the roaming decision is based on the identification information. In some embodiments, the roaming proxy 512 determines that additional identification information is required to make the roaming decision.

The roaming decision can further be based on the restricted roaming list. For example, the roaming proxy 512 can compare the identification information associated with the PDU session request with the restricted roaming list. Upon determining that the identification information associated with the PDU session request matches an entry in the restricted roaming list, the roaming proxy 512 can send a roaming decision to reject the PDU session request to the hSMF 510. Alternatively, upon determining that the identification information does not match an entry in the restricted roaming list, the roaming proxy 512 can send a roaming decision to allow the PDU session request to the hSMF 510. In some embodiments, the hSMF 510 periodically updates the restricted roaming list using the identification information.

At Operation 528, after sending a roaming decision to reject the PDU session request to the hSMF 510, the roaming proxy 512 sends a notification to a network node 514 of the home network 507, such as HSS or UDM, to initiate de-registration of the wireless device 502. At Operation 530, the network node 414 de-registers the wireless device 502 from the vAMF 504.

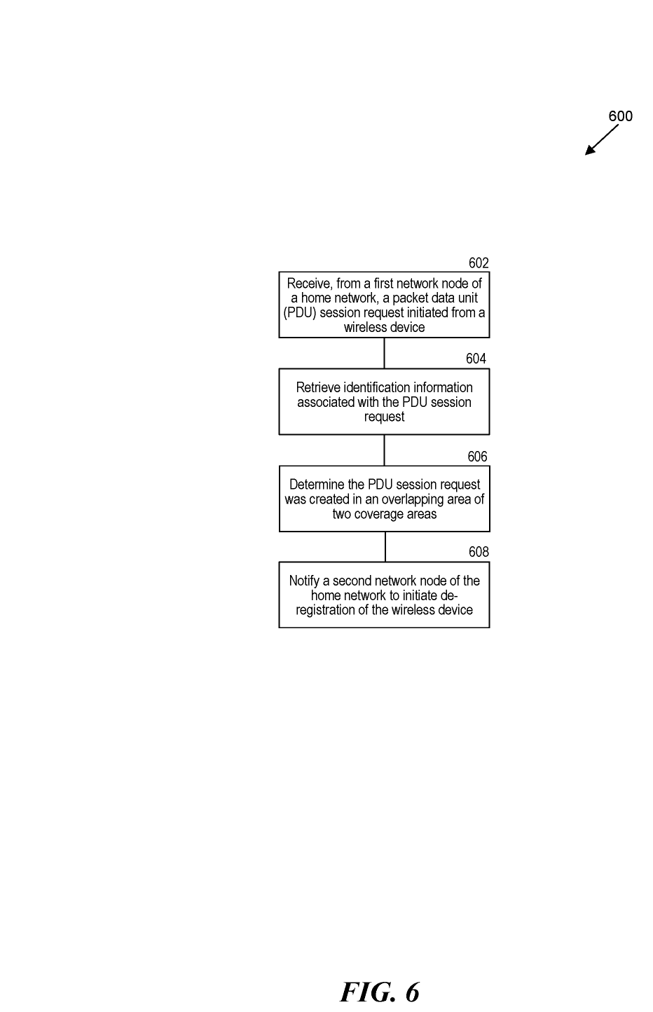

FIG. 6 is a flowchart representation of an example process 600 for routing a PDU session request in an overlapping coverage area in accordance with one or more embodiments of the present technology. At Operation 602, a roaming proxy of a home network receives a packet data unit (PDU) session request initiated from a wireless device. The wireless device initiates the PDU session request by sending a message to a visited network’s AMF. The vAMF subsequently routes the PDU session request to a first network node of the home network, such as SMF or SEPP. The first network node then routes the PDU session request to the roaming proxy.

At Operation 604, the roaming proxy retrieves identification information associated with the PDU session request. The identification information can include information related to the PDU session request, such as MCC, MNC, cell ID of a cell identified in the PDU session request, or TAC associated with the PDU session request.

At Operation 606, based on the retrieved identification information, the roaming proxy determines that the PDU session request was created in an overlapping area of coverage areas of the home network and the visited network. In some embodiments, the roaming proxy maintains a restricted roaming list of MCC, MNC, TAC, and cell ID. Upon comparing the identification information associated with the PDU session request and the restricted roaming list, the roaming proxy can determine that the PDU session request was created in the overlapping area by confirming that the identification information matches an entry in the restricted roaming list. In some implementations, upon determining that the PDU session request was created in the overlapping area, the roaming proxy updates the restricted roaming list with the identification information associated with the PDU session request created in the overlapping area.

At Operation 608, the roaming proxy notifies a second network node of the home network to initiate de-registration of the wireless device from the vAMF. In some embodiments, prior to notifying the second network node, the roaming proxy transfers a message to the first network node to reject the PDU session request. Upon receiving the notification from the roaming proxy, the second network node, such as HSS or UDM of the home network, de-registers the wireless device from the vAMF.

### Computer System

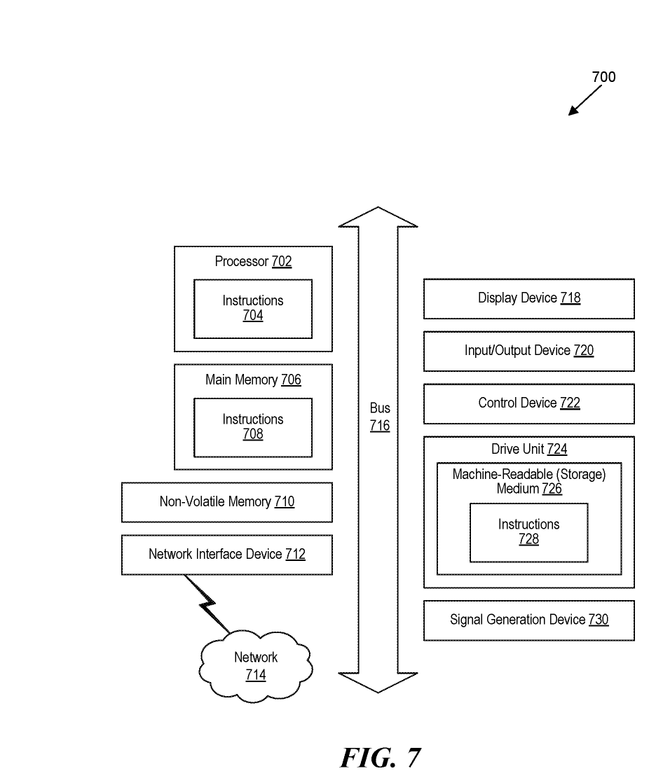

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, a video display device 718, an input/output device 720, a control device 722 (e.g., keyboard and pointing device), a drive unit 724 that includes a machine-readable (storage) medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in this specification can be implemented.

The computer system 700 can take any suitable physical form. For example, the computing system 700 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 700. In some implementations, the computer system 700 can be an embedded computer system, a system-on-chip (SOC), a single-board computer system (SBC), or a distributed system such as a mesh of computer systems, or it can include one or more cloud components in one or more networks. Where appropriate, one or more computer systems 700 can perform operations in real time, in near real time, or in batch mode.

The network interface device 712 enables the computing system 700 to mediate data in a network 714 with an entity that is external to the computing system 700 through any communication protocol supported by the computing system 700 and the external entity. Examples of the network interface device 712 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 706, non-volatile memory 710, machine-readable medium 726) can be local, remote, or distributed. Although shown as a single medium, the machine-readable medium 726 can include multiple media (e.g., a centralized/distributed database and/or associated caches and servers) that store one or more sets of instructions 728. The machine-readable medium 726 can include any medium that is capable of storing, encoding, or carrying a set of instructions for execution by the computing system 700. The machine-readable medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computing system 700 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A method for telecommunication, comprising:
receiving, by a roaming proxy of a home network, from a first network node of the home network, a packet data unit (PDU) session request initiated from a wireless device;
retrieving, by the roaming proxy, identification information associated with the PDU session request,
wherein the identification information includes at least one of: mobile country code (MCC), mobile network code (MNC), cell ID of a cell identified in the PDU session request, or tracking area code (TAC);
based on the identification information, determining, by the roaming proxy, the PDU session request was created in an overlapping area of two coverage areas,
wherein the two coverage areas comprise a first coverage area of a first access node in the home network and a second coverage area of a second access node in a visited network; and
notifying a second network node of the home network to initiate de-registration of the wireless device from the visited network.

2. The method of claim 1, wherein the PDU session request is received by the first network node of the home network from an Access and Mobility management Function (AMF) of the visited network and routed to the roaming proxy of the home network.

3. The method of claim 1, wherein the second network node is a Home Subscriber Server (HSS) or a Unified Data Management (UDM).

4. The method of claim 1, further comprising:
prior to notifying the second network node, transferring, by the roaming proxy, a message to the first network node of the home network to reject the PDU session request.

5. The method of claim 1, wherein the first network node is a Security Edge Protection Proxy (SEPP) of the home network.

6. The method of claim 5, wherein the roaming proxy maintains a restricted roaming list, the determining further comprising:
comparing the identification information with the restricted roaming list; and
confirming that the identification information matches an entry in the restricted roaming list.

7. The method of claim 1, wherein the first network node is a Session Management Function (SMF) of the home network.

8. The method of claim 7, wherein receiving the PDU session request by the roaming proxy further comprises:
receiving, by the roaming proxy, the identification information associated with the PDU session request,
wherein the identification information is stored in the SMF.

9. The method of claim 7, wherein the SMF maintains a restricted roaming list, the determining further comprising:
receiving, by the roaming proxy, the restricted roaming list from the SMF;
comparing the identification information with the restricted roaming list; and
confirming that the identification information matches an entry in the restricted roaming list.

10. A device for telecommunication implemented as a roaming proxy of a home network, comprising:
a processor, and
a memory configured to store instructions, wherein the instructions when executed cause the processor to:
receive, from a first network node of the home network, a packet data unit (PDU) session request initiated from a wireless device;
retrieve identification information associated with the PDU session request,
wherein the identification information includes at least one of: mobile country code (MCC), mobile network code (MNC), cell ID of a cell identified in the PDU session request, or tracking area code (TAC);
based on the identification information, determine whether the PDU session request was created in an overlapping area of two coverage areas,
wherein the two coverage areas comprise a first coverage area of a first access node in the home network and a second coverage area of a second access node in a visited network.

11. The device of claim 10, wherein the first network node is a Security Edge Protection Proxy (SEPP) or a Session Management Function (SMF) of the home network.

12. The device of claim 10, wherein the instructions further cause the roaming proxy to:
upon determining the PDU session request was created in the overlapping area of the two coverage areas, transfer a message to the first network node of the home network to reject the PDU session request; and
notify a second network node of the home network to initiate de-registration of the wireless device from the visited network.

13. The device of claim 12, wherein the second network node is a Home Subscriber Server (HSS) or a Unified Data Management (UDM).

14. The device of claim 10, wherein the instructions further cause the roaming proxy to:
upon determining the PDU session request was created outside the overlapping area of the two coverage areas, transfer a message to the first network node of the home network to allow the PDU session request.

15. The device of claim 10, wherein the roaming proxy maintains a restricted roaming list, the instructions further causing the roaming proxy to:
compare the identification information with the restricted roaming list; and
confirm whether the identification information matches an entry in the restricted roaming list.

16. The device of claim 15, wherein the instructions further cause the roaming proxy to:
update the restricted roaming list using the identification information.

17. The device of claim 10, wherein the first network node is configured to maintain a restricted roaming list, the instructions further causing the roaming proxy to:
receive the restricted roaming list from the first network node;
compare the identification information with the restricted roaming list; and
confirming whether the identification information matches an entry in the restricted roaming list.

18. A system for telecommunication, the system comprising:
a roaming proxy of a home network;
a first network node of the home network; and
a second network node of the home network;
wherein the first network node of the home network is configured to:
receive, from a network node of a visited network, a packet data unit (PDU) session request initiated from a wireless device; and
route the PDU session request to the roaming proxy;
wherein the roaming proxy is configured to:
receive, from the first network node of the home network, the PDU session request;
retrieve identification information associated with the PDU session request,
wherein the identification information includes at least one of: mobile country code (MCC), mobile network code (MNC), cell ID of a cell identified in the PDU session request, or tracking area code (TAC);
based on the identification information, determine the PDU session request was created in an overlapping area of two coverage areas,
wherein the two coverage areas comprise a first coverage area of a first access node in the home network and a second coverage area of a second access node in the visited network;
transfer a message to the first network node of the home network to reject the PDU session request; and
notify the second network node of the home network to initiate de-registration of the wireless device from the visited network;
wherein the first network node of the home network is further configured to:
reject the PDU session request from the network node of the visited network; and
wherein the second network node of the home network is configured to:
send a de-registration request to the network node of the visited network.

19. The system of claim 18, wherein the first network node is a Security Edge Protection Proxy (SEPP) or a Session Management Function (SMF) of the home network.

20. The system of claim 18, wherein the second network node is a Home Subscriber Server (HSS) or a Unified Data Management (UDM).
